(19) United States
(12) Patent Application Publication
(10) Pub. No.: US 2010/0027132 A1
(43) Pub. Date: Feb. 4, 2010

(54) OBJECTIVE LENS AND OBJECTIVE LENS ADAPTER

(75) Inventor: Tadashi HIRATA, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/509,692

(22) Filed: Jul. 27, 2009

(30) Foreign Application Priority Data
Jul. 30, 2008 (JP) 2008-197045

(51) Int. Cl. G02B 21/02

(52) U.S. Cl. 359/656

(57) ABSTRACT

Especially when observing brain tissue, damage inflicted on the brain tissue is reduced, and light from the brain tissue is collected to the utmost extent. The invention provides an objective lens in which a tip transparent member that is made to contact an observation object is formed to gradually narrow towards an end face thereof, a diameter d of the end face being defined by the following expression, and a maximum diameter D being 3 mm or less:

0 mm≦d−FOV−2×WD×(NA/N)≦0.3 mm

where FOV is the observation field of view, WD is the working distance, NA is the numerical aperture, and N is the refractive index of the observation object.

### BACKGROUND OF THE INVENTION

1. Field of the Invention

The present invention relates to an objective lens and an objective lens adapter.

This application is based on Japanese Patent Application No. 2008-197045, the content of which is incorporated herein by reference.

2. Description of Related Art

As an objective lens that is attached to the tip of a microscope for in vivo observation of biological tissue, in the related art there is a known liquid-immersion objective optical system with a high numerical aperture, in which multiple lenses are arranged inside an outer tube, with a narrow outer diameter and long overall length, and in which chromatic aberrations are suitably corrected (for example, see Japanese Unexamined Patent Application, Publication No. 2006-119300).

This objective optical system is provided with a plano-convex lens having a flat end face at the tip and can collect a considerable amount of the light entering via the end face.

However, although the objective optical system in Japanese Unexamined Patent Application, Publication No. 2006-119300 is formed in a long, narrow shape to reduce the damage inflicted on the biological tissue when inserting the objective optical system therein, a transparent member at the tip has a cylindrical side face shape, and therefore, the surface area of the end face thereof is larger than the surface area required to ensure the proper field of view in practice. Because of this, when inserting the objective optical system into the biological tissue, a region of the biological tissue larger than the required surface area ends up being pressed, and therefore, there is a possibility of inflicting damage on the biological tissue. Especially in the case where brain tissue is to be observed as the biological tissue, it is essential to reduce the damage inflicted on the brain tissue to the utmost minimum.

### BRIEF SUMMARY OF THE INVENTION

The present invention has been conceived in light of the circumstances described above, and an object thereof is to provide an objective lens and an objective lens adapter in which, especially when observing brain tissue, damage inflicted on the brain tissue can be reduced, and light from the brain tissue can be collected to the utmost extent.

In order to realize the above object, the present invention provides the following solutions.

A first aspect of the present invention is an objective lens in which a tip transparent member that is made to contact an observation object is formed to gradually narrow towards an end face thereof, a diameter d of the end face being defined by the following expression, and a maximum diameter D being 3 mm or less:

0 mm≦d−FOV−2×WD×(NA/N)≦0.3 mm

where FOV is the observation field of view, WD is the working distance, NA is the numerical aperture, and N is the refractive index of the observation object.

According to the first aspect of the present invention, because the tip transparent member formed to gradually narrow towards the end face is made to contact the observation object, the end face having the smallest surface area is placed in contact with the observation object. Because the diameter d of the end face is set to range from the minimum required size for obtaining the observation field of view to a size allowing a margin for preventing fabrication-induced distortion of the image, even when the end face is pressed against the observation object, the end face does not press the observation object in wider than the required range, and it is thus possible to reduce the damage inflicted on the observation object. In addition, by forming the tip transparent member in a tapered shape that gradually widens from the end face, it is possible to allow the observation target in contact therewith to escape along the inclined surface. Accordingly, of the insertion force applied to the objective lens, the force component applied directly to the observation object can be reduced, thus further reducing the damage inflicted on the observation object.

In the first aspect described above, a tip widening angle φ at one side of the tip transparent member may be defined by the following expression:

sin⁻¹(NA/n)≦φ<90°

where n is the refractive index of the tip transparent member.

By doing so, the light incident on the end face is relayed to the subsequent optical system without being vignetted by the inclined surface, and therefore, it is possible to obtain a bright image of the observation object.

In the configuration described above, the tip widening angle φ at one side of the tip transparent member is preferably φ≦60°.

By doing so, it is possible to allow the observation object in contact with the inclined surface to escape along the inclined surface, and of the insertion force applied to the objective lens, the force component applied directly to the observation object can be reduced, which further reduces the damage inflicted on the observation object.

A second aspect of the present invention is an objective lens adapter in which a tip transparent member that is provided so as to be attachable to and detachable from an objective lens and that is disposed at a tip of the objective lens and brought into contact with an observation object is formed to gradually narrow towards an end face thereof, a diameter d of the end face being defined by the following expression, and a maximum diameter D being 3 mm or less:

0 mm≦d−FOV−2×WD×(NA/N)≦0.3 mm

where FOV is the observation field of view, WD is the working distance, NA is the numerical aperture, and N is the refractive index of the observation object.

According to the second aspect of the present invention, by attaching the objective lens adapter to the objective lens, the tip transparent member disposed at the end of the objective lens is made to contact the observation object; therefore, the end face with the smallest surface area is made to contact the observation object. The diameter d of the end face is set to range from the minimum required size for obtaining the observation field of view to a size allowing a margin for preventing fabrication-induced distortion of the image. Therefore, even when the end face is pressed against the observation object, the end face does not press the observation object in wider than the required range, and it is thus possible to reduce the damage inflicted on the observation object. In addition, by forming the transparent member in a tapered shape that gradually widens from the end face, it is possible to allow the observation object in contact therewith to escape along the incline surface. Accordingly, of the insertion force applied to the objective lens, the force component applied directly to the observation object can be reduced, thus further reducing the damage inflicted on the observation object.

In the second aspect described above, the tip widening angle φ at one side of the tip transparent member may be defined by the following expression:

sin⁻¹(NA/n)≦φ≦90°

where n is the refractive index of the tip transparent member.

In the above-described configuration, the tip widening angle φ at one side of the tip transparent member is preferably φ≦60°.

According to the present invention, an advantage is afforded in that, especially when brain tissue is to be observed, it is possible to reduce the damage inflicted on the brain tissue and to collect light from the brain tissue to the utmost extent.

### BRIEF DESCRIPTION OF THE SEVERAL VIEWS OF THE DRAWINGS

FIG. 1 is a front view showing an objective lens according to an embodiment of the present invention.

FIG. 2 is a partial longitudinal sectional view showing an end portion of the objective lens in FIG. 1.

FIG. 3 is a longitudinal sectional view showing the end portion of the objective lens in FIG. 1 inserted into an observation object.

FIG. 4 is a partial longitudinal sectional view showing an end portion of a first modification of the objective lens in FIG. 1.

FIG. 5 is a partial longitudinal sectional view showing an end portion of a second modification of the objective lens in FIG. 1.

FIG. 6 is a partial longitudinal sectional view showing an end portion of a third modification of the objective lens in FIG. 1.

FIG. 7 is a partial longitudinal sectional view showing an end portion of a fourth modification of the objective lens in FIG. 1.

FIG. 8 is a longitudinal sectional view showing an objective lens adapter according to an embodiment of the present invention.

FIG. 9 is a longitudinal sectional view showing a modification of the objective lens adapter in FIG. 8.

### DETAILED DESCRIPTION OF THE INVENTION

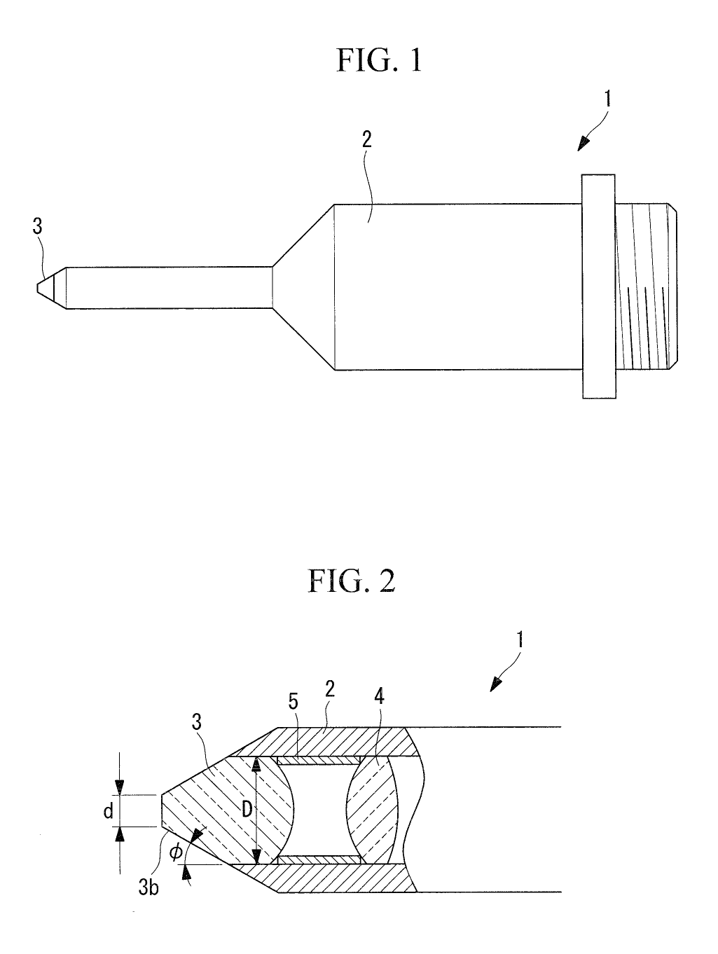

An objective lens 1 according to an embodiment of the present invention will be described below with reference to FIGS. 1 to 3.

As shown in FIGS. 1 and 2, the objective lens 1 according to this embodiment is provided with a plurality of lenses 3 and 4 inside a lens barrel 2, and the front lens (tip transparent member) 3 disposed at the extreme distal end thereof has a minimum diameter d at the tip, given by expression (1) below, and a maximum diameter D=3 mm or less.

0 mm≦d−FOV−2×WD×(NA/N)≦0.3 mm (1)

Here, FOV is the observation field of view, WD is the working distance, NA is the numerical aperture, and N is the refractive index of the observation object.

In this figure, reference numeral 4 is the second lens from the tip, and reference numeral 5 is a spacing member disposed between the front lens 3 and the lens 4.

The front lens 3 has a tapered surface 3b that gradually narrows towards an end face 3a. The taper angle (the tip widening angle at one side) φ of the tapered surface 3b is an angle within the range given by expression (2) below.

sin⁻¹(NA/n)≦φ<90° (2)

Here, n is the refractive index of the front lens 3.

A taper angle of φ≦60° is preferred.

The operation of the objective lens 1 according to this embodiment will be described below.

With the objective lens 1 according to this embodiment, because the diameter d of the end face 3a is set in the range shown in expression (1), at the lower limit in expression (1), the diameter d is the required minimum diameter for the combination of the observation field of view FOV and spreading of the light from the observation object A according to the working distance WD. Accordingly, it is possible to prevent vignetting of the light from the observation object A by the end face 3a, allowing the light to be collected efficiently.

On the other hand, at the upper limit in expression (1), the diameter d is ensured to be increased by a margin (0.15 mm in the radial directions) in which the field of view is distorted because of surrounding burrs resulting from fabrication of the front lens 3. Accordingly, the light collected from the observation object A can be collected without distortion, allowing a clear image to be acquired.

Because the side face of the front lens 3 is formed of the tapered surface 3b which gradually narrows towards the end face 3a, and because the taper angle φ thereof is set in the range in expression (2), at the lower limit in expression (2), it is possible to prevent the problem of the light incident on the end face 3a being vignetted by the inner face of the tapered surface 3b.

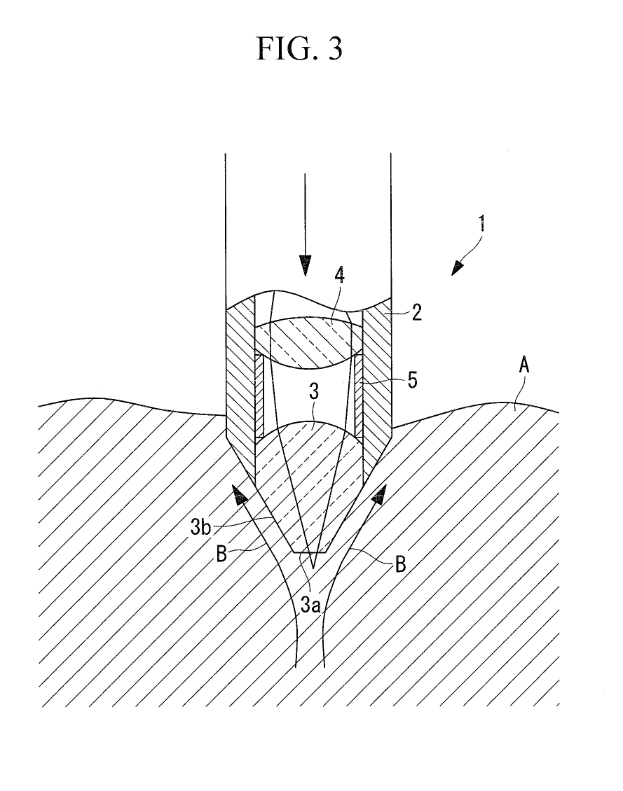

At the upper limit in expression (2), the inclined tapered surface 3b can be provided around the end face 3a, and as shown in FIG. 3, when the tip of the objective lens 1 pierces brain tissue, serving as the observation object A, the brain tissue escapes along the inclined tapered surface 3b as shown by the arrows B, and therefore, direct damage to the brain tissue can be prevented.

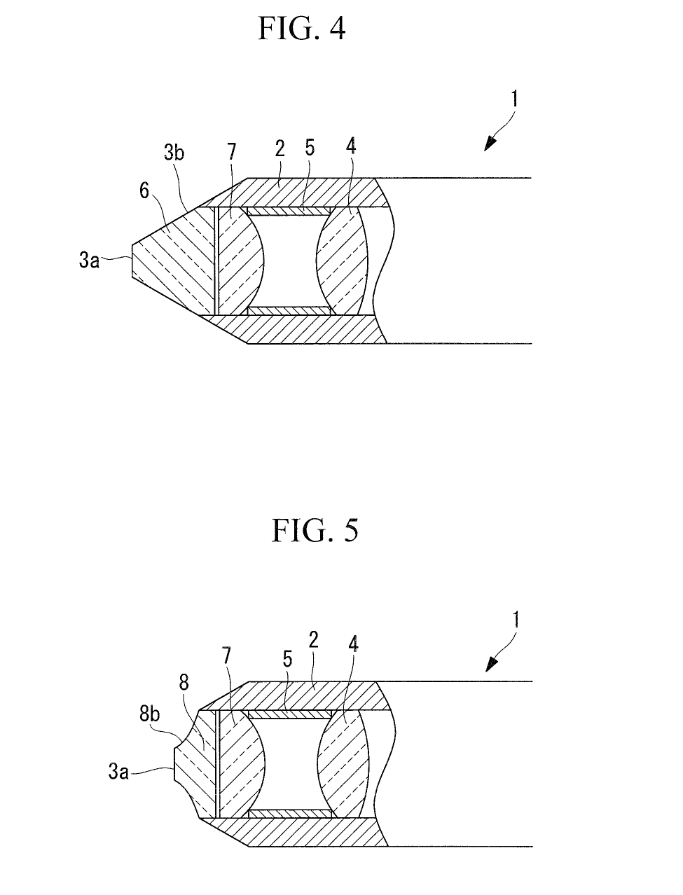

In this embodiment, the front lens 3 is provided with the tapered surface 3b that gradually narrows towards the end face 3a; instead of this, however, as shown in FIG. 4, the front lens 3 may be separated into a parallel flat plate (tip transparent member 6) and a plano-convex lens 7. In this case, the parallel flat plate 6 disposed at the tip may be provided with the tapered surface 3b. In addition, forming the parallel flat plate 6 disposed at the tip of a hard material such as sapphire glass or the like increases the strength, making it difficult to break due to an impact. Also, it is possible to employ a structure that is difficult to break by using light-transmitting plastic.

Instead of the tapered surface 3b, as shown in FIG. 5, it is possible to employ a curved surface 8b whose inclination angle changes such that the taper angle φ condition shown in expression (2) above is satisfied only in the vicinity of the end face 3a. In this case, the thickness of the front lens 3 or the parallel flat plate 6 can be reduced.

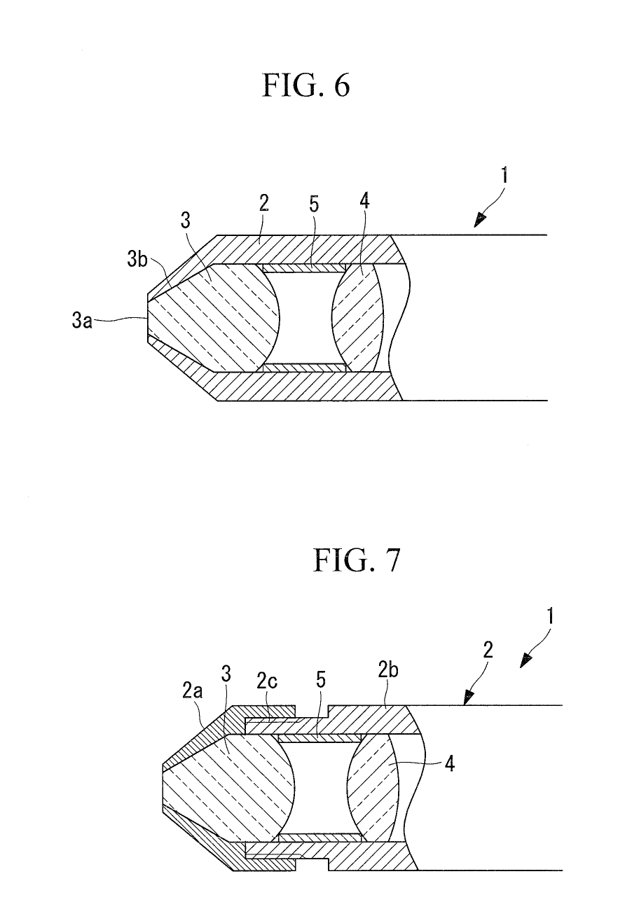

As shown in FIG. 6, a structure in which the front lens 3 is enclosed by the lens barrel 2 up to and including the tapered surface 3b rather than being exposed may be employed. Additionally, in this case, as shown in FIG. 7, it is possible to employ a structure in which the lens barrel 2 that encloses the tapered surface is divided into two members 2a and 2b, and the front lens 3 is bonded to the lens barrel 2a and then to the lens barrel 2b, or alternatively the lens barrel 2a and 2b and the front lens 3 are fastened with a screw 2c, which simplifies the fabrication of the lens barrel 2 and makes it easier to attach the front lens 3.

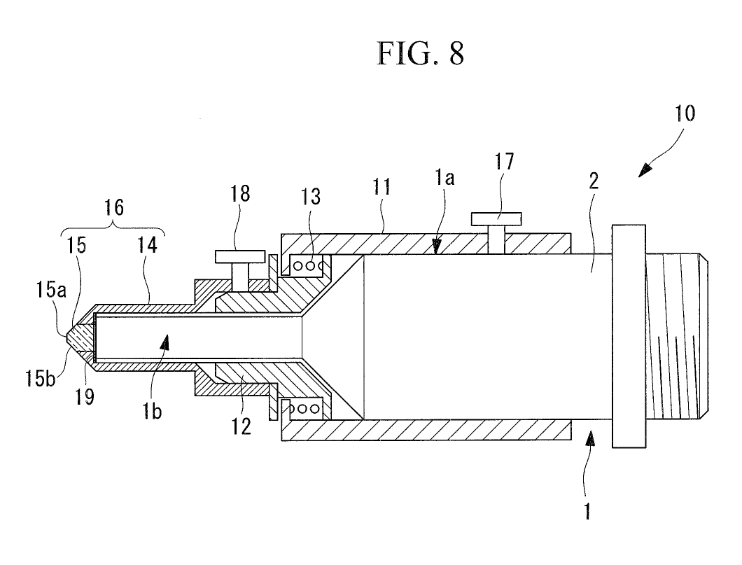

Next, an objective lens adapter 10 according to an embodiment of the present invention will be described below with reference to FIG. 8.

As shown in FIG. 8, the objective lens adapter 10 according to this embodiment, which is an adapter that is attachable to the tip of an objective lens 1 including a large-diameter portion 1a and a small-diameter end portion 1b having a smaller diameter than the large-diameter portion 1a, includes a first member 11 that is fixed to the large-diameter portion 1a, a second member 12 provided so as to be movable in the axial direction relative to the first member 11, a coil spring 13 that urges the second member 12 rearward relative to the first member 11, and a third member 16 including a tubular portion 14, which is fixed to the second member 12 and sheathes the small-diameter end portion 1b of the objective lens 1, and a parallel flat plate (tip transparent member) 15, which is disposed at the end of the tubular member 14 and is disposed in front of the front lens of the small-diameter end portion 1b.

In FIG. 8, reference numeral 17 is a lock screw for securing the first member 11 to the large-diameter portion 1a, reference numeral 18 is a lock screw for securing the third member 16 to the second member 12, and reference numeral 19 is a spacer sandwiched between the front lens and the parallel flat plate 15.

The diameter d, the maximum diameter D, and the taper angle φ of the end face 15a of the parallel flat plate 15 are the same as those in the objective lens 1 according to the first embodiment described above.

To attach the thus-configured objective lens adapter 10 according to this embodiment on the objective lens 1, first, the third member 16 is secured to the second member 12 with the lock screw 18. Next, the small-diameter end portion 1b of the objective lens 1 is inserted through the second member 12 into the tubular portion 14 of the third member 16, and the large-diameter portion 1a of the objective lens 1 is fitted inside the first member 11. At this time, by bringing the end face of the small-diameter end portion 1b into contact with the spacer 19 and pressing the end face of the small-diameter end portion 1b and the spacer 19 together with a prescribed force, the lock screw 17 provided on the first member 11 is tightened while the coil spring 13 is elastically deformed. Accordingly, the parallel flat plate 15 of the third member 16 is kept in close contact with the end face of the small-diameter end portion 1b of the objective lens 1, with the spacer 19 interposed therebetween.

With the objective lens adapter 10 according to this embodiment, similarly to the objective lens 1 according to the first embodiment, even when inserted into brain tissue serving as the observation object A, the brain tissue A can escape along the tapered surface 15b of the parallel flat plate 15, and therefore, it is possible to prevent the problem of an excessive external force being applied to the brain tissue.

In addition, because it is detachably mounted to the tip of the objective lens 1, even if the parallel flat plate 15 at the tip breaks, it is possible to repair the parallel flat plate 15 at comparatively low cost with a suitable replacement.

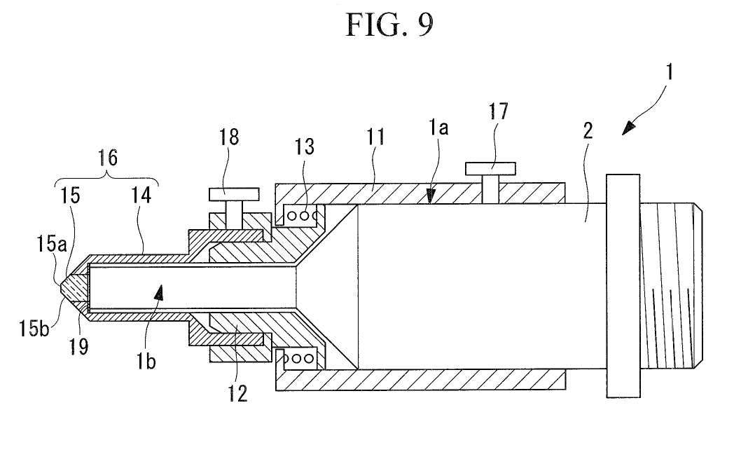

In this embodiment, the third member 16 is provided with the lock screw 18; instead of this, however, as shown in FIG. 9, the second member 12 may be provided with the lock screw 18. With this configuration, by removing the lock screw 18 from the third member 16, which contacts the observation object A, the third member 16 can remain in place piercing the observation object A.

In this embodiment, a description has been given illustrating the objective lens 1 provided with the plurality of lenses 3 and 4 inside the lens barrel 2; instead of this, however, the present invention may be applied to an objective lens 1 having a GRIN lens, that is to say, a refractive-index distribution lens (not shown in the drawings).

Although brain tissue has been illustrated as an example of the observation object A; the present invention may be applied to observation objects other than the observation object A.

What is claimed is:

1. An objective lens wherein a tip transparent member that is made to contact an observation object is formed to gradually narrow towards an end face thereof,
a diameter d of the end face being defined by the following expression, and a maximum diameter D being 3 mm or less:
0 mm≦d−FOV−2×WD×(NA/N)≦0.3 mm
where FOV is the observation field of view, WD is the working distance, NA is the numerical aperture, and N is the refractive index of the observation object.

2. An objective lens according to claim 1, wherein a tip widening angle φ at one side of the tip transparent member is defined by the following expression:
sin⁻¹(NA/n)≦φ≦90°
where n is the refractive index of the tip transparent member.

3. An objective lens according to claim 2, wherein the tip widening angle φ at one side of the tip transparent member is φ≦60°.

4. An objective lens adapter wherein a tip transparent member that is provided so as to be attachable to and detachable from an objective lens and that is disposed at a tip of the objective lens and brought into contact with an observation object is formed to gradually narrow towards an end face thereof,
a diameter d of the end face being defined by the following expression, and a maximum diameter D being 3 mm or less:
0 mm≦d−FOV−2×WD×(NA/N)≦0.3 mm
where FOV is the observation field of view, WD is the working distance, NA is the numerical aperture, and N is the refractive index of the observation object.

5. An objective lens adapter according to claim 4, wherein a tip widening angle φ at one side of the tip transparent member is defined by the following expression:
sin⁻¹(NA/n)≦φ≦90°
where n is the refractive index of the tip transparent member.

6. An objective lens adapter according to claim 5 wherein the tip widening angle φ at one side of the tip transparent member is φ≦60°.
